(19) United States
(12) Patent Application Publication
(10) Pub. No.: US 2010/0052642 A1
(43) Pub. Date: Mar. 4, 2010

(54) SYSTEM AND METHOD FOR USING A PHY'S DISCOVERY OF CABLE SHIELDING FOR POWER OVER ETHERNET CURRENT CAPACITY SETTING AND TEMPERATURE DE-RATING

(75) Inventors: Wael William Diab, San Francisco, CA (US); Scott Powell, Carlsbad, CA (US)

Correspondence Address: LAW OFFICE OF DUANE S. KOBAYASHI, P.O. Box 4160, Leesburg, VA, 20177, US

(73) Assignee: Broadcom Corporation, Irvine, CA (US)

(21) Appl. No.: 12/198,187

(22) Filed: Aug. 26, 2008

(51) Int. Cl. G05F 3/02

(52) U.S. Cl. 323/304

(57) ABSTRACT

A system and method for using a physical layer device's discovery of cable shielding for PoE current capacity setting and temperature de-rating. Headroom in a particular cable installation is increased when it is determined that the physical layer device is coupled to a shielded cable, which more effectively removes heat from a bundled cable. By the determination of the type of cabling, the current capable of being carried over the cable can be increased and/or the temperature de-rating decreased due to the removal of limitations of worst-case cable assumptions.

### BACKGROUND

1. Field of the Invention

The present invention relates generally to power over Ethernet (PoE) systems and methods and, more particularly, to a system and method for using a physical layer device's discovery of cable shielding for PoE current capacity setting and temperature de-rating.

2. Introduction

PoE specifications such as IEEE 802.3af and 802.3at provide a framework for delivery of power from power sourcing equipment (PSE) to a powered device (PD) over Ethernet cabling. Various types of PDs exist, including voice over IP (VoIP) phones, wireless LAN access points, Bluetooth access points, network cameras, computing devices, etc.

FIG. 1 illustrates an example of a conventional power over Ethernet (PoE) system. As illustrated, the PoE system includes PSE 120 that transmits power to powered device (PD) 140 over two wire pairs. Power delivered by the PSE to the PD is provided through the application of a voltage across the center taps of a first transformer that is coupled to a transmit (TX) wire pair and a second transformer that is coupled to a receive (RX) wire pair carried within an Ethernet cable.

As is further illustrated in FIG. 1, PD 140 includes PoE module 142. PoE module 142 includes the electronics that would enable PD 140 to communicate with PSE 120 in accordance with a PoE specification such as IEEE 802.3af (PoE), 802.3at (PoE Plus), legacy PoE transmission, or any other type of PoE transmission. PD 140 also includes controller 144 (e.g., pulse width modulation DC:DC controller) that controls power FET 146, which in turn provides constant power to load 150.

In general, PoE is a relatively new application that is being applied to an existing cabling infrastructure. Significantly, this cabling infrastructure was not originally designed for the distribution of power. Accordingly, the provision of power over the cabling infrastructure can be impacted by the presence of heat, which reduces the capacity of the cable to transmit power and data.

Heat can be present due to a variety of sources. For example, heat can be present in the ambient environment or can be generated through the transmission of current in the cable itself or in surrounding cables. This heat problem gets significantly worse with cable bundles due to the difficulty of dissipating heat from within the cable bundle. PoE systems must account for this heat during operation. To mitigate this heat problem, typical system operation would apply a de-rating from the worst case that the cable is rated to allow for the heat that may be generated by the PoE transmission.

As would be appreciated, these considerations will play an even greater role in the administration of high-power PoE systems such as that proposed by the IEEE 802.3at specification. What is needed therefore is a mechanism that enables the PoE system to account for the existence of heat in an active manner during system operation.

### SUMMARY

A system and/or method for using a physical layer device's discovery of cable shielding for PoE current capacity setting and temperature de-rating, substantially as shown in and/or described in connection with at least one of the figures, as set forth more completely in the claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an embodiment of a Power over Ethernet (PoE) system.

FIG. 2 illustrates an embodiment of a PoE environment at a PSE location.

FIG. 3 illustrates a flowchart of a process of a first embodiment of the present invention.

FIG. 4 illustrates an example of temperature rise for shielded and unshielded cabling.

FIG. 5 illustrates a flowchart of a process of a second embodiment of the present invention.

FIG. 6 illustrates an example of temperature rise for different cabling types.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

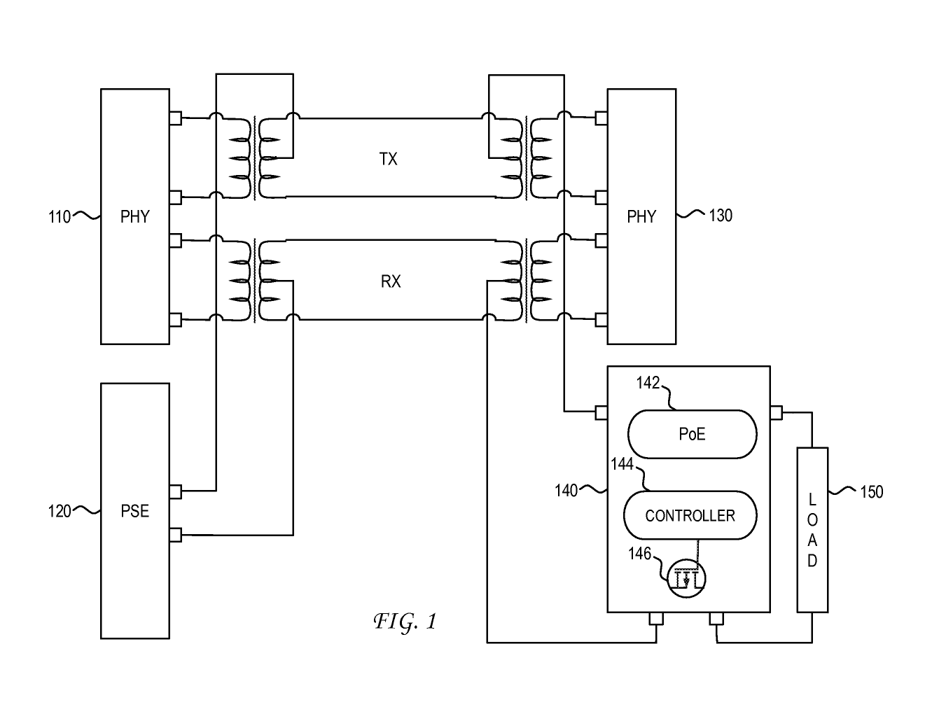

In the example of IEEE 802.3af, a PSE can deliver up to 15.4W of power to a plurality of PDs. In FIG. 1, only one PD is shown for simplicity. In IEEE 802.3at, on the other hand, a PSE can potentially deliver up to 30 W of power to a PD over 2-pairs or 60 W of power to a PD over 4-pairs. Other proprietary solutions can potentially deliver even higher levels of power to a PD. In general, high power PoE Plus solutions are often limited by the limitations of the cabling such as the cabling type, shielding, bundle size, etc.

In IEEE 802.3af, each wire conductor has a specified current limit of 175 mA, resulting in a total specified current limit of 350 mA. IEEE 802.3at, on the other hand, identifies higher wire conductor current limits to accommodate higher power applications. Regardless of the current limits that have been defined for a particular PoE application, one of the key considerations is heat.

Heat can greatly impact system performance. As the temperature goes up, cable attenuation also increases. For certain cable types, for example, cable attenuation can increase at a rate of 0.4% for every degree Celsius above 20° C. This can continue up to a typical cable temperature rating of 60° C. Heat can therefore have an impact on data transmission. As heat can also change the DC resistance of the cable, it also has an impact on the transmission of power over the cable. More generally, heat has a direct effect on safety and the long-term life expectancy of the cable itself.

In a PoE application, the net effect of the passage of current through the wire conductor is a temperature increase of the conductor itself. The heat generated by this temperature increase is then dissipated into the environment. This dissipated heat is in addition to the heat currently present as reflected by the ambient temperature. As noted, typical system operation would apply a de-rating from the worst case that the cable is rated to allow for the heat that may be generated by the PoE transmission.

Further exacerbating the situation is the diverse environments in which the cable is placed. For example, increased heating can be experienced in areas where airflow is restricted, such as in a cable conduit, wiring closet, or the like. As typical installations include cables bundled together or in close proximity, temperature effects are typically magnified in areas where cable deployments are concentrated. For example, it is not uncommon to see massive bundles of cables (e.g., 90-150) leaving a data center or wiring closet.

When considering power delivery over data cabling infrastructure (e.g., Cat 3, 5, 5e, 6, 6a, 7, etc.), there is a tradeoff between thermal temperature rise in cable bundles and the amount of current capacity allowed. One key factor that impacts the amount of current that carried on the cabling for a given level of thermal rise is whether or not the cabling is shielded.

Typically, cabling is either unshielded (e.g., Unshielded Twisted Pair) or shielded (e.g., Shielded Twisted Pair or Foil Twisted Pair). Unlike conventional unshielded cabling, shielded cabling includes metal shielding over each individual pair of copper wires.

Cabling simulations and measured data for power delivery indicate that shielded cabling provides considerable performance improvement. This is due in part to the fact that the metal shielding over each individual pair of copper wires helps dissipate the heat from the inner core of the cable bundle. This heat dissipation benefit increases in significance with larger cable bundles.

One of the concerns of higher power PoE Plus systems is the impact of overly conservative temperature restrictions that are derived from worst-case operating conditions. These overly conservative temperature restrictions can significantly reduce the legitimate operating margins of those PoE Plus systems. Conventional systems assume that the cabling is unshielded because that type of cabling is the worst type for heat dissipation.

In the present invention, it is recognized that the physical layer device (PHY) has the capability to detect whether or not shielding exists in the cabling. In one embodiment, a controller in a transceiver can be configured to analyze the correction coefficients and the correction signal of various crosstalk cancellation filters. This analysis can lead to a determination of whether shielded cabling is present. An example of such a detection mechanism is described in non-provisional patent application Ser. No. 11/610,381, entitled “Transceiver with Automatic Detection of Unshielded Twisted Pair or Shielded Twisted Pair Cabling,” filed Dec. 13, 2006, which is incorporated herein by reference in its entirety. Detection of whether or not shielding exists in the cabling can also benefit the PHY itself.

It is a feature of the present invention that the detection of shielded/unshielded cabling can be used by a PoE device (e.g., PSE) to impact the provision of power across the cabling. As will be described in detail below, the identification of the type of cabling (i.e., shielded or unshielded) can be used by a PoE device in the provisioning process. In one embodiment, the PoE device can provision more current than that permitted for the amount of allowable temperature rise in the cabling. For example, the current PoE Plus specification allow for a 10 degree rise in the cabling. This allowable temperature rise can be produced when 600 mA of current per pair is carried on a bundle of unshielded Cat 5e cabling. In comparison, the same allowable temperature rise can be produced when 820 mA of current per pair is carried on a bundle of shielded Cat 5e cabling. This difference of 220 mA of current per pair is a significant amount of current capacity that is lost if worst case operating conditions are assumed. Thus, for example, for a worst case PSE voltage of 50V, 220 mA translates into 11 W that can be regained by the PoE system. In another embodiment, the PoE device can use a reduced temperature de-rate for a given current level.

One of the goals of the present invention is to ensure that an imposition of a current limitation, power consumption restriction, or other power provisioning restriction on a port/channel is only performed when it is needed. If the PHY detects that the cabling is shielded, then the PoE subsystem can have the option to use higher currents for the same temperature de-rating, or use a lower temperature de-rating for a given current level. As would be appreciated, a combination of these two options can also be used.

In conventional PoE systems, there is typically no knowledge of whether the PSE and PD are connected using shielded or unshielded cabling. Accordingly, control in the power allocation/management process would typically assume a worst-case scenario of unshielded cabling. As noted above, this leads to overly broad provisioning restrictions.

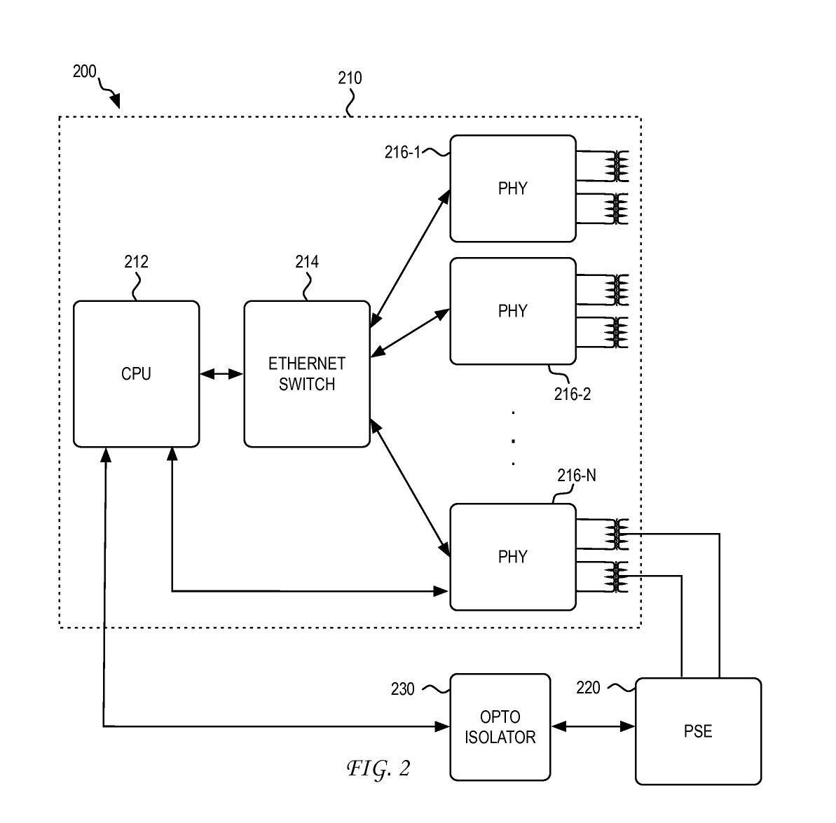

FIG. 2 illustrates an embodiment of a PoE environment 200 at a PSE location in which the principles of the present invention can be implemented. As illustrated, environment 200 includes PHYs 216-1 to 216-N that are each connected to Ethernet switch 214. While a PHY can include one or more Ethernet transceivers, the wiring for only a single transceiver is illustrated as being connected to the PHYs=. As would be appreciated, a PHY can be discrete or integrated as part of Ethernet switch 214. Each PHY is also connected to CPU 212, although only a single connection from CPU 212 to PHY 216-N is shown for simplicity. In one embodiment, CPU 212 is incorporated along with Ethernet switch 214 and PHYs 216-1 to 216-N on a single chip 210. In another embodiment, Ethernet switch 214 and PHYs 216-1 to 216-N are incorporated on a single chip separate from CPU 212, wherein communication with CPU 212 is enabled via a serial interface. Also illustrated in PoE environment 200 is a PSE 220 that provides power through the center taps of the transformers of PHY 216-N. For simplicity, only a single PSE is shown. As illustrated, PSE 220 is also coupled to CPU 212 via opto-isolator 230 that facilitates an isolation boundary.

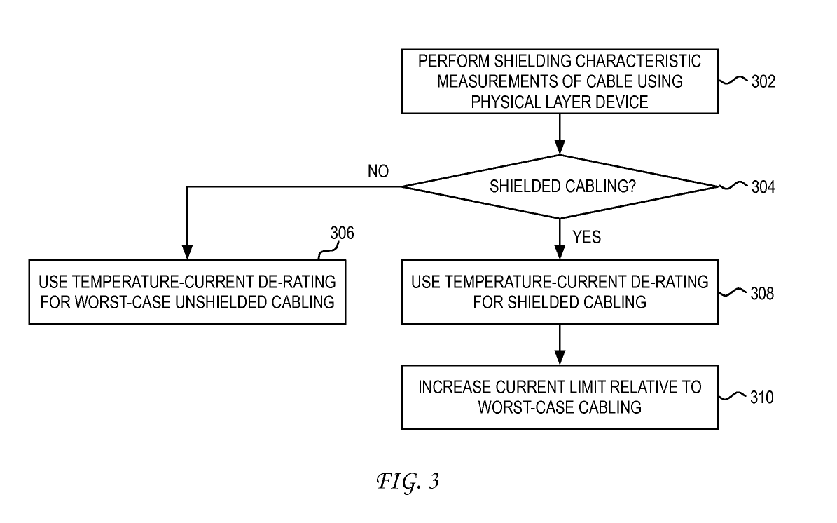

To illustrate the operation of PoE environment 200 in implementing one embodiment of the present invention, reference is now made to the flowchart of FIG. 3. As illustrated, the process begins at step 302, where shielding characteristic measurements of a cable are taken by a PHY. In various embodiments, the shielding characteristic measurements can be taken upon provisioning of the data channel, provisioning of power on the particular PoE channel, etc. In one embodiment, a transceiver in a PHY at the PSE location performs measurements of an Ethernet cable coupled to the PHY. In an alternative embodiment, the shielding characteristic measurements could also be taken by the Ethernet transceiver at the PD either alone or in combination with the transceiver at the PSE.

Based on these shielding characteristic measurements, it is then determined at step 304 whether the cabling is shielded. If it is determined at step 304 that the cabling is unshielded, then the process continues to step 306 where the conventional temperature-current de-rating for worst-case unshielded cabling is used. In other words, the current limits imposed for worst-case unshielded cabling at the temperature allowance for specified PoE current cable heating can be used (e.g., 10 degree rise for PoE Plus).

If, on the other hand, it is determined at step 304 that the cabling is shielded, then the process continues to step 308 where the temperature-current de-rating for shielded cabling is used. As noted above, shielded cabling and unshielded cabling will produce the same allowable temperature rise using vastly different current levels.

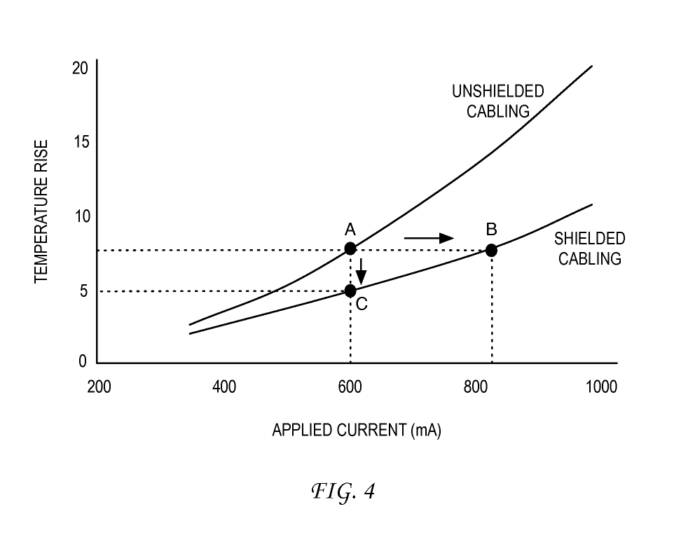

FIG. 4 illustrates an example of such a scenario for Cat 5e cabling. As would be appreciated, this example is for a particular bundling size and configuration and would not be limiting on the principles of the present invention. As illustrated, the temperature rise that fits into a 10-degree heat specification (e.g., approximately 7.5 degrees), can be produced when 600 mA of current per pair is carried on unshielded cabling. This same allowable temperature rise can be produced when 820 mA of current per pair is carried on shielded cabling. In FIG. 4, this change in system operation is illustrated by the movement from point A on the unshielded cabling curve to point B on the shielded cabling curve.

The resulting difference of 220 mA of current per pair allows for increased current budgets for the same temperature de-rating. Accordingly, at step 310, the PSE can increase the current level for the previously determined temperature de-rate point for that PoE channel.

In general, the increased current limit at a given de-rating can provide the PD with additional flexibility in its operation. For example, the increased current limit can enable the PD to power additional devices. For instance, the PD can be a laptop or a VoIP phone that has multiple USB slots. If more current is allowed, then that translates to a higher power budget for powering of additional devices that plug into the PD. In another example, the PD itself can source PoE power or have another outlet of power. Here, the PD can have a PSE in it that would power a lower-power PD downstream.

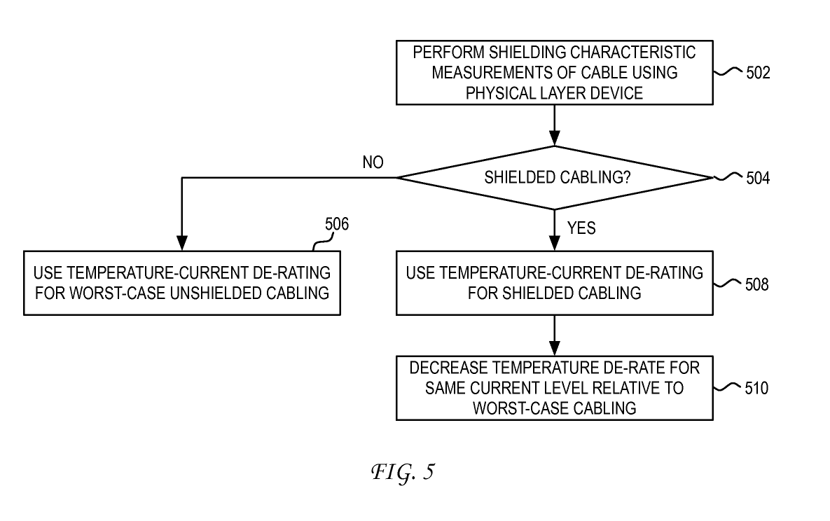

The flowchart of FIG. 5 illustrates a second embodiment of a process of the present invention. As illustrated, the process begins at step 502, where shielding characteristic measurements of a cable are taken by a PHY. Based on these shielding characteristic measurements, it is then determined at step 504 whether the cabling is shielded. If it is determined at step 504 that the cabling is unshielded, then the process continues to step 506 where the conventional temperature-current de-rating for worst-case unshielded cabling is used.

If, on the other hand, it is determined at step 504 that the cabling is shielded, then the process continues to step 508 where the temperature-current de-rating for shielded cabling is used. As illustrated in the example of FIG. 4, the temperature de-rating for shielded cabling is significantly lower then that for unshielded cabling. For example, for a current level of 600 mA of current per pair, a temperature rise of approximately 7.5 degrees is produced on unshielded cabling. When this same current level is carried on shielded cabling, then the temperature rise is reduced to approximately 5 degrees. In FIG. 4, this change in temperature rise is illustrated by the movement from point A on the unshielded cabling curve to point C on the shielded cabling curve.

The resulting difference in temperature rise of approximately 2.5 degrees allows for decreased temperature de-rating for the same current levels. Accordingly, at step 510, the PSE can decrease the temperature de-rate for that PoE channel relative to the temperature de-rate that would have been applied assuming the existence of worst-case unshielded cabling. In one example, the change in de-rating can have a significant impact on the qualification of devices.

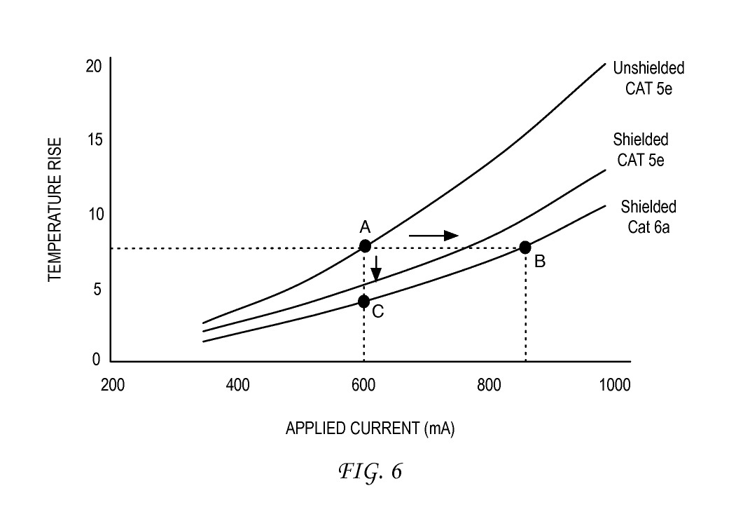

As would be appreciated, the identification of the existence of shielded/unshielded cabling can be used in combination with other discovered heat-related parameters that can be used to further identify the particular current budget that can be applied to the PoE channel. For example, the existence of shielded/unshielded cabling can be used in combination with the discovery of cabling type (e.g., Cat 3, 5, 5e, 6, 6a, 7, etc.). As illustrated in the example of FIG. 6, temperature-current de-rating curves are provided for unshielded Cat 5e, shielded Cat 5e, and shielded Cat 6a cabling. In this illustrated example, the identification of the different cabling types along with the detection of shielded/unshielded cabling can be used to increase the current limit or reduce the temperature de-rating. An example of the discovery of cabling type using measurements such as insertion loss, cross talk, and length of the cable is described in non-provisional patent application Ser. No. 11/654,023, entitled “System and Method for Controlling Power Delivered to a Powered Device Based on Cable Characteristics,” which is incorporated herein by reference in its entirety. Additionally, the detection of ambient temperature can also be used in combination with the detection of shielded/unshielded cabling. As would be appreciated, any parameter (e.g., length of the cable, existence of connectors, etc.) that can directly or indirectly (e.g., through the discovery of cable resistance) provide an indication of the relevant heat for a particular PoE channel can be used.

In general, the shielded/unshielded cabling analysis can be performed at the PSE and/or PD. For example, the analysis can be performed at the PSE using data that is generated at the PSE and/or PD. In another example, the analysis can be performed at the PD using data that is generated at the PSE and/or PD. If the data is generated remotely from the point of analysis, then the data communication can occur via a Layer 1 scheme, such as voltage and/or current modulation, Layer 2 (packets), Layer 3 (packets), or any such combination. Packets may be a standard protocol such as Ethernet, LLDP, OAM, or a proprietary system over these protocols.

In general, the use of the shielded/unshielded measurement enables the system to determine an amount of headroom remaining in the cabling for PoE current transmission. Without the shielded/unshielded measurement, the system would need to assume a conservative amount of headroom that is derived from a worst-case of unshielded cabling. Excess headroom in a particular cable installation would therefore be left unused.

As would be appreciated, the particular mechanism by which the headroom would be determined would be implementation dependent. What is key, however, is that the information gained through the shielded/unshielded measurement would enable the system to more accurately calculate a current-induced cabling temperature rise. Once a determination is made of whether shielded or unshielded cabling is being used, the system can then determine how much current or temperature de-rating to use for that particular cable installation. Significantly, this determination is based on the characteristics of that particular installation, not a worst-case scenario.

It should be noted that the principles of the present invention can be applied to any form of network cabling, whether standard Ethernet cabling (e.g., Category 3, 5, 5e 6, 6A, 7, 7A, etc. and their ISO versions Class C, D, E, etc.) or to non-standard cabling such as Type-II cabling. It should also be noted that the principles of the present invention can be broadly applied to various contexts, such as in all types of PHYs (e.g., backplane, twisted pair, optical, etc.), including energy efficient Ethernet PHYs and extended reach Ethernet PHYs. Moreover, the principles of the present invention can be applied to standard or non-standard (e.g., 2.5 G, 5 G, etc.) link rates, as well as future link rates (e.g., 40 G, 100 G, etc.). Also, the principles of the present invention can be applied to various two-pair and four-pair PoE applications.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A power over Ethernet method, comprising:
measuring a characteristic of an Ethernet cable by a physical layer device, said Ethernet cable coupling a power sourcing equipment to a powered device;
determining based on said measured characteristic whether said Ethernet cable is a shielded cable; and
controlling a provisioning of power on said Ethernet cable based on said determination.

2. The method of claim 1, wherein said measuring comprising measuring in said power sourcing equipment.

3. The method of claim 1, wherein said measuring comprising measuring in said powered device.

4. The method of claim 1, wherein said determining comprising determining in said power sourcing equipment.

5. The method of claim 1, wherein said determining comprising determining in said powered device.

6. The method of claim 1, wherein said controlling comprises changing a current limit.

7. The method of claim 1, wherein said controlling comprises changing a power consumption at said powered device.

8. The method of claim 1, wherein said controlling comprises changing a temperature de-rating.

9. A power over Ethernet method, comprising:
determining whether an Ethernet cable that couples a power sourcing equipment to a powered device is a shielded cable; and
controlling a provisioning of power by said power sourcing equipment on said Ethernet cable if said determination indicates that said Ethernet cable is a shielded cable.

10. The method of claim 9, wherein said determination uses measurements at said power sourcing equipment.

11. The method of claim 9, wherein said determination uses measurements at said powered device.

12. The method of claim 9, wherein said controlling comprises changing a current limit.

13. The method of claim 9, wherein said controlling comprises changing a temperature de-rating.

14. The method of claim 9, wherein said controlling is also based on a determination of a resistance of said Ethernet cable.

15. A power over Ethernet method in a system that sets a current limit for a power sourcing equipment port to a first value when the power sourcing equipment port is coupled to an unshielded cable, comprising:
measuring a characteristic of a cable by a physical layer device;
transmitting said measured cable characteristic to a controller;
determining, by said controller, whether said cable is a shielded cable; and
controlling, by said controller, a provisioning of power for a power sourcing equipment port, which is coupled to said cable, based on said determination.

16. The method of claim 15, wherein said measuring comprises measuring in a power sourcing equipment.

17. The method of claim 15, wherein said measuring comprises measuring in a powered device.

18. The method of claim 15, wherein said transmitting comprises transmitting over said cable.

19. The method of claim 15, wherein said controlling comprises changing a current limit.

20. The method of claim 15, wherein said controlling comprises changing a temperature de-rating.
